(19) United States
(12) Patent Application Publication
(10) Pub. No.: US 2017/0118962 A1
(43) Pub. Date: May 4, 2017

(54) FLUID AGITATION SYSTEM OF AN IN OVO INJECTION APPARATUS, AND ASSOCIATED METHOD

(71) Applicant: Zoetis Services LLC, Parsippany, NJ (US)

(72) Inventor: Thomas Matthew Hessler, Raleigh, NC (US)

(21) Appl. No.: 15/333,236

(22) Filed: Oct. 25, 2016

Related U.S. Application Data
(60) Provisional application No. 62/247,874, filed on Oct. 29, 2015.

(51) Int. Cl. A01K 45/00

(52) U.S. Cl. CPC A01K 45/007

(57) ABSTRACT

A fluid delivery system implemented within an in ovo injection apparatus is disclosed. The fluid delivery system includes a fluid agitation system having a plurality of pump assemblies each in fluid communication with an injection delivery device. The pump assemblies include a membrane pump and a plurality of membrane valves interconnected by fluid channels. The membrane pump and membrane valves have a diaphragm configured in open and closed positions for agitating a fluid treatment substance by reversing flow of the fluid treatment substance within the fluid channels.

### CROSS REFERENCE TO RELATED APPLICATION

This application claims the benefit of U.S. Provisional Patent Application No. 62/247,874, filed Oct. 29, 2015, which is expressly incorporated herein by reference in its entirety.

### TECHNICAL FIELD

The presently disclosed subject matter relates generally to fluid agitation systems and more particularly to a fluid agitation system implemented within an in ovo injection apparatus, wherein the fluid agitation system comprises a plurality of pump assemblies configured to agitate fluid.

### BACKGROUND

In many instances, it is desirable to introduce a substance into a live avian egg prior to hatch. An injection of various substances into avian eggs is commonly referred to as “in ovo injection.” Such injections have been employed to decrease post-hatch mortality rates, increase the potential growth rates or eventual size of the resulting bird, and even to influence the gender determination of the embryo. Similarly, injections of antigens into live eggs have been employed to incubate various substances used in vaccines that have human or animal medicinal or diagnostic applications. Examples of substances that have been used for, or proposed for, in ovo injection include, but are not limited to, vaccines, antibiotics, and vitamins. In addition, removal of material from avian eggs using similar processes and/or equipment has been employed for various purposes, such as testing and vaccine harvesting.

An egg injection apparatus (i.e., in ovo injection apparatus) may comprise a plurality of injection devices that operate simultaneously or sequentially to inject a plurality of eggs. The injection apparatus may comprise an injection head which comprises the injection devices, and wherein each injection device is in fluid communication with a source containing a treatment substance to be injected. The in ovo injection apparatus conventionally is designed to operate in conjunction with commercial egg carrier carriers or flats. Egg flats utilized in conjunction with an in ovo injection apparatus typically contain an array of pockets that are configured to support a respective plurality of avian eggs in a generally upright orientation. The egg flats may be typically transported through the in ovo injection apparatus via an automated conveyor system for registering the egg flat beneath the injection head for injection of the eggs carried by the egg flat. In ovo injection of substances (as well as in ovo extraction of materials) typically occurs by piercing an egg shell to form an opening (e.g., via a punch), extending an injection needle through the hole and into the interior of the egg (and in some cases into the avian embryo contained therein), and injecting treatment substance(s) through the needle and/or removing material therefrom.

The fluid delivery system for implementation within an in ovo injection apparatus may encounter vaccine fluid that is difficult to transport through the system for various reasons. For example, the vaccine fluid may be particularly viscous or sticky, or otherwise contain foreign particulates that clog the system. In addition, some vaccine fluids may be of a nature that leaves residual vaccine fluid within the fluid delivery system. In some instances, the components of the vaccine fluid may settle within the fluid delivery system, thereby causing clogs or clumps to form. Accordingly, new approaches are needed for unclogging or otherwise cleaning/clearing the fluid paths of a fluid delivery system of an in ovo injection apparatus.

Additionally, in a fluid delivery system, the vaccine fluids may not be homogenous at the vaccine source, leading to varied homogeneity and potentially reduced efficacy. Moreover, the components of the vaccine fluid may settle within the fluid delivery system, thereby also leading to a varied homogeneity of the vaccine fluid. Accordingly, new approaches are needed for generating or otherwise maintaining a homogeneous vaccine fluid flow within a fluid delivery system.

### SUMMARY

This Summary is provided to introduce a selection of concepts in a simplified form that are further described below in the Detailed Description section. This Summary is not intended to identify key features or essential features of the claimed subject matter, nor is it intended to be used to limit the scope of the claimed subject matter.

According to some aspects of the present disclosure, a fluid delivery system implemented within an in ovo injection apparatus includes a fluid agitation system having a plurality of pump assemblies, each in fluid communication with an injection delivery device. The pump assemblies include a membrane pump and a plurality of membrane valves interconnected by fluid channels. The membrane pump and membrane valves have a diaphragm configured in open and closed positions for agitating a fluid treatment substance by reversing flow of the fluid treatment substance within the fluid channels.

According to other aspects of the present disclosure, a method of agitating a fluid treatment substance within a fluid delivery system of an in ovo injection apparatus is provided. The method comprises providing a plurality of pump assemblies in fluid communication with respective injection delivery devices via fluid channels. The method further comprises operating the pump assemblies so as to agitate a fluid treatment substance by alternatingly moving the fluid treatment substance in forward and backward directions within the fluid channels.

Thus, various aspects of the present disclosure provide advantages, as otherwise detailed herein.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 is a partial cross-sectional view of an in ovo injection delivery device capable of delivering a treatment substance into an avian egg;

FIG. 2 is a side view of an in ovo injection apparatus having a plurality of injection devices, wherein the in ovo injection apparatus comprises a fluid delivery system, according to one aspect of the present disclosure;

FIG. 3 is a plan view of a portion of the presently disclosed fluid delivery system and showing an example arrangement of pump assemblies comprising membrane valves, according to one aspect of the present disclosure; and

FIG. 4 through FIG. 8 show cross-sectional side views of an example of the pump assembly and a process of agitating a fluid therewith, according to one aspect of the present disclosure.

### DETAILED DESCRIPTION

The presently disclosed subject matter now will be described more fully hereinafter with reference to the accompanying Drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

In some embodiments, the presently disclosed subject matter provides a fluid agitation system implemented within an in ovo injection apparatus, wherein the fluid agitation system comprises a plurality of pumps/valves. In particular, the fluid agitation system includes a diaphragm pump/valve system that may be used to agitate a fluid.

An exemplary in ovo processing system that may be utilized to inject a substance, particularly substances such as oil-based and aqueous-based treatment substances or vaccines, into eggs in accordance with aspects of the present disclosure, is the system known as INOVOJECT® egg injection apparatus, manufactured by Zoetis Inc. (Applicant of the present application). However, aspects of the present disclosure may be utilized with any in ovo processing device.

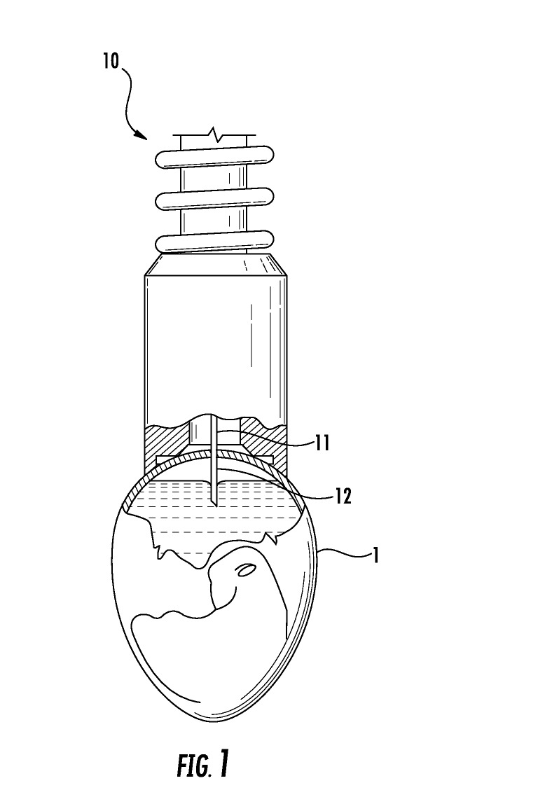

Referring now to FIG. 1, a partial cross-sectional view of an in ovo injection delivery device 10 that is capable of delivering a treatment substance into an avian egg is depicted. In this example, in ovo injection delivery device 10 is the in ovo injection delivery device of the Zoetis INOVOJECT® egg injection apparatus. The injection delivery device 10 includes a punch 11 configured to form an opening in the shell of an egg 1. An injection needle 12 may be movably disposed within the punch 11 (i.e., the punch 11 may substantially concentrically surround the respective injection needle 12) so that after the punch 11 makes an opening in the shell of an egg, the injection needle 12 may move through the punch 11 and respective opening of an egg shell to an injecting position(s) within an egg for delivery of one or more substances therein. However, various types of injection delivery devices may be utilized in accordance with aspects of the present disclosure. Aspects of the present disclosure are not limited to the illustrated injection delivery device.

After injection of one or more treatment substances into an egg via the injection delivery device 10 of FIG. 1, or the removal of material from the egg, portions of the punch 11 and needle 12 may be treated with a sanitizing fluid, for example, via spraying, dipping, and/or allowing sanitizing fluid to flow through the needle and/or punch, and the like.

As used herein, the term “treatment substance” may refer to a substance that is injected into an egg to achieve a desired result. Similarly, dosing or dosage may refer to one unit of a treatment substance, meaning one unit of a treatment substance for a respective egg. Treatment substances may include, but are not limited to, vaccines, antibiotics, vitamins, virus, and immunomodulatory substances. Treatment substances may also include certain vaccines designed for in ovo use to combat outbreaks of avian diseases in the hatched birds that may be produced by the user and/or commercially available. In some embodiments, the treatment substance is dispersed in a fluid medium, e.g., a fluid or emulsion, or is a solid dissolved in a fluid, or a particulate dispersed or suspended in a fluid.

As used herein, the term “needle” or “injection needle” may refer to an instrument designed to be inserted into an egg to deliver a treatment substance into the interior of the egg. The term “needle” or “injection needle” may also refer to an instrument designed to be inserted into an egg to remove material therefrom. A number of suitable needle designs will be apparent to those skilled in the art. The term “injection tool” as used herein may refer to a device designed to both pierce the shell of an avian egg and inject a treatment substance therein and/or remove material therefrom. Injection tools may comprise a punch for making a hole in the egg shell, and an injection needle that is inserted through the hole made by the punch to inject a treatment substance in ovo. Various designs of injection tools, punches, and injection needles will be apparent to those in the art.

As used herein, “in ovo injection” may refer to the placing of a substance within an egg prior to hatch. The substance may be placed within an extraembryonic compartment of the egg (e.g., yolk sac, amnion, allantois) or within the embryo itself. The site into which injection is achieved will vary depending on the substance injected and the outcome desired, as will be apparent to those skilled in the art.

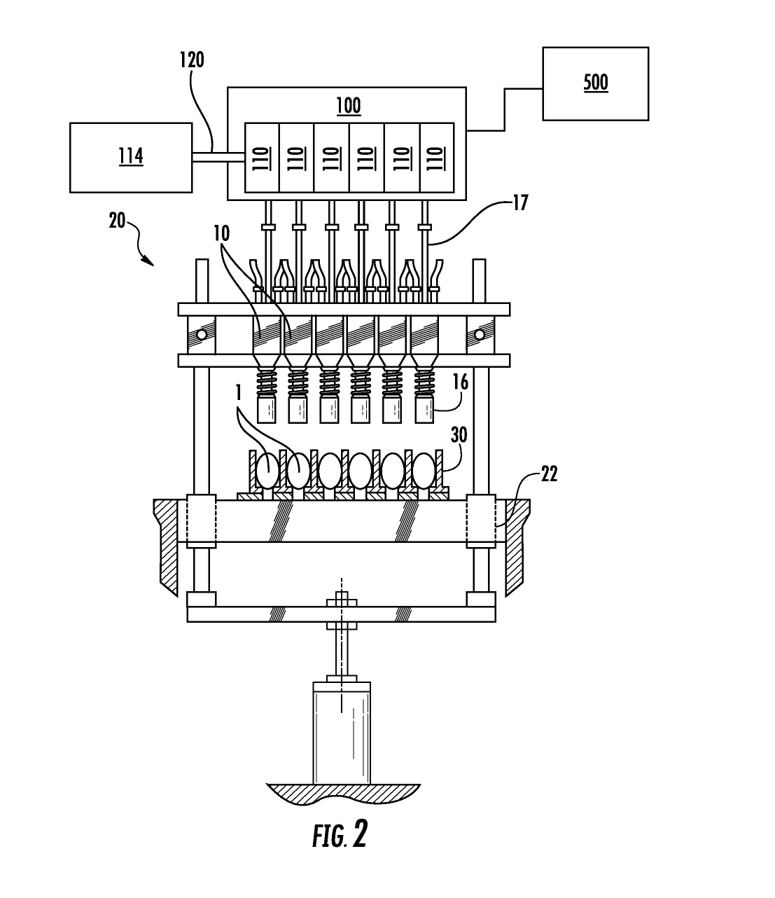

Referring now to FIG. 2, a side view of an in ovo injection apparatus 20 comprising a plurality of the injection delivery devices 10 shown in FIG. 1 is shown. The injection apparatus 20 may be fluidly coupled to a fluid delivery system 100, according to one aspect of the present disclosure.

The injection delivery devices 10 of the injection apparatus 20 may be configured to inject one or more substances in multiple eggs according to aspects of the present disclosure. The injection apparatus 20 may include a stationary base 22 in relation to the plurality of injection delivery devices 10.

A flat 30 holds a plurality of eggs 1 in a substantially upright position. The flat 30 may be configured to provide external access to predetermined areas of the eggs 1. Each egg 1 may be held by the flat 30 so that a respective end thereof is in proper alignment relative to a corresponding one of the injection delivery devices 10 as the injection delivery device 10 advances towards the base 22 of the apparatus. However, in ovo injection devices may inject eggs oriented in various orientations. Aspects of the present disclosure are not limited only to in ovo injection devices that inject eggs in the illustrated orientation.

Each of the plurality of injection delivery devices 10 may have opposing first and second ends 16 and 17, respectively. The injection delivery devices 10 may have a first extended position and a second retracted position. Upon extension of an injection delivery device 10, the first end 16 may be configured to contact and rest against predetermined areas of an external egg shell. From this position, a punch 11 (see FIG. 1) within the injection delivery device 10 may form a small opening in the shell, thereby allowing the injection needle 12 (see FIG. 1) to be inserted therethrough to deliver one or more substances into the egg 1 and/or remove materials therefrom. When not injecting, the injection delivery devices 10 may be retracted to rest at a predetermined distance above the eggs 1 and stationary base 22. Alternatively, the base 22 can be longitudinally slidably moveable (e.g., a conveyor) to position the eggs 1 in proper position relative to the injection delivery devices 10.

Each injection delivery device 10 may be configured to deliver discrete amounts of a treatment substance. Namely, a fluid delivery system 100 may supply a treatment substance to the injection delivery devices 10. The fluid delivery system 100 may include a plurality of pump assemblies 110 that also function to form and provide a fluid agitation system 200. For example, one pump assembly 110 for each of the injection delivery devices 10 (e.g., twelve pump assemblies 110 for twelve injection delivery devices 10). The upstream sides of the pump assemblies 110 may be fluidly coupled to a fluid reservoir 114 via a fluid channel 120. The downstream sides of the pump assemblies 110 may be fluidly coupled to the second end 17 of each of the injection delivery devices 10. The pump assemblies 110 in the fluid delivery system 100 may be arranged in a manifold in fluid communication with the fluid reservoir 114. The pump assemblies 110 may be used to pump the treatment substance from the fluid reservoir 114 through the injection delivery devices 10, while also being used to agitate the treatment substance.

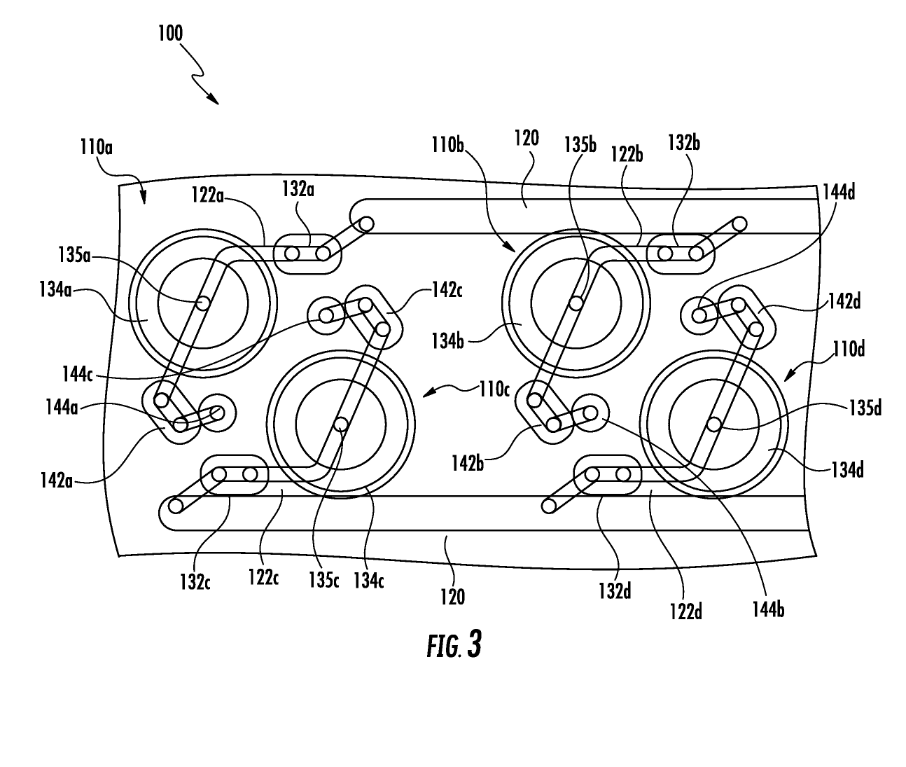

Aspects of the present disclosure are not limited to the illustrated configurations of a single fluid delivery system 100. For example, more than one fluid reservoir 114 may be utilized for each injection apparatus 20. In this regard, a plurality of fluid delivery systems 100 may be implemented to provide more than one treatment substances. In some instances, each pump assembly 110 may be used to deliver more than one treatment substance to the injection delivery devices 10. More details of an example of the pump assemblies 110 are shown and described hereinbelow with reference to FIG. 3 through FIG. 8.

Referring now to FIG. 3, a plan view of a portion of the presently disclosed fluid agitation system 200 is shown, illustrating an example arrangement of pump assemblies 110 comprising membrane valves and pumps, according to one aspect of the present disclosure. By way of example, FIG. 3 shows four pump assemblies 110 (e.g., pump assemblies 110a, 110b, 110c, 110d).

The pump assemblies 110 may be advantageously used with the injection delivery devices 10. Each pump assembly 110 may include a fluid channel 122 that interconnects a set of membrane valves/pumps. For example, in pump assembly 110, the fluid channel 122 may interconnect, in order, an input valve 132, a diaphragm pump 134, and an outlet valve 142.

In each pump assembly 110, the input valve 132 may be used to fluidly couple the fluid channel 120 from the fluid reservoir 114 to a first end of the fluid channel 122. In this way, the fluid reservoir 114 may supply the pump assembly 110. An outlet port 144 may be provided at a second end of the fluid channel 122 of the pump assembly 110, wherein the input valve 132, the diaphragm pump 134, and the outlet valve 142 may be arranged between the first and second ends of the fluid channel 122. The outlet port 144 of each pump assembly 110 may be fluidly coupled to the second end 17 of one of the injection delivery devices 10. The pump assembly 110 may be optimally configured for pumping fluids, such as one or more fluids for injection into eggs as provided herein.

In some embodiments, the fluid path for each pump assembly 110 is as follows. The fluid channel 120 supplies an inlet of the input valve 132. An outlet of the input valve 132 supplies an inlet/outlet 135 of the diaphragm pump 134 via the fluid channel 122. The inlet/outlet 135 of the diaphragm pump 134 supplies an inlet of the outlet valve 142 via the fluid channel 122. An outlet of the outlet valve 142 supplies the outlet port 144 via the fluid channel 122.

In each pump assembly 110, the diaphragm pump 134 is typically, though not necessarily, the larger of the valves/pumps. Namely, the diaphragm pump 134 is used to meter out a precise volume of treatment substance. Accordingly, the size of the diaphragm pump 134 is designed for metering out a selected precise volume of treatment substance. In some embodiments, the diaphragm pump 134 is configured to dispense a selected precise volume of treatment substance accurate to within ±5%. In one example, the diaphragm pump 134 is designed to accurately dispense a dose of about 50 μl of treatment substance. Various other dosage volumes, both greater than and less than the about 50 μl example, are also envisioned. In some embodiments, dosages may be accurately measured by the diaphragm pump 134 to within ±10%.

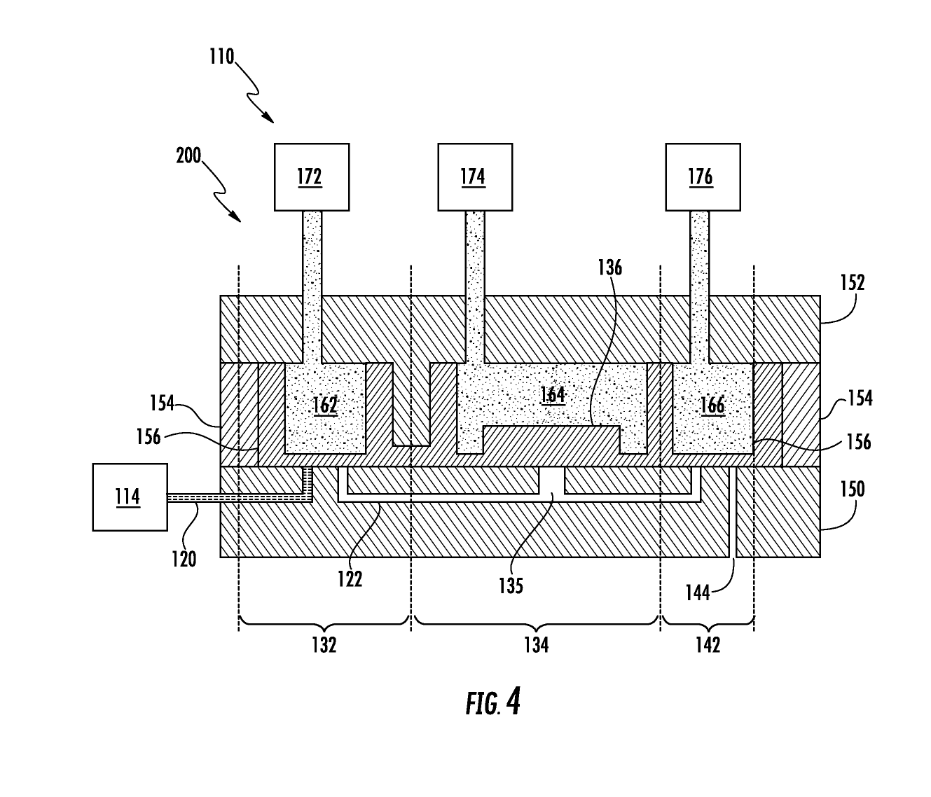

Referring now to FIG. 4 through FIG. 8, cross-sectional side views of an example of the pump assembly 110 and a process of agitating a treatment substance therewith, according to one aspect of the present disclosure, are illustrated. The pump assembly 110 may include a first panel (or substrate) 150 and a second panel (or substrate) 152 that are held a certain distance apart via, for example, one or more spacers 154, thereby defining a chamber therebetween. The first panel 150, the second panel 152, and the spacers 154 may be formed, for example, of a metal, polymer, composite or similar material.

The first panel 150 may define the fluid channel 122 therein. The fluid channel 122 may be configured as illustrated, or may take on any other appropriate configurations. The fluid channel 122 may be configured to receive a fluid treatment substance from the fluid reservoir 114, wherein the fluid reservoir 114 is coupled to the first panel 150 via the fluid channel 120. The fluid reservoir 114 may supply, for example, treatment substance fluids 180 to be injected into an egg.

A resilient membrane layer 156 may be provided in the chamber between the first panel 150 and the second panel 152. The resilient membrane layer 156 is typically flexible and/or stretchable. The resilient membrane layer 156 can be, for example, a silicone elastomer material or a fluoroelastomer material, such as the Dyneon™ brand fluoropolymers. The resilient membrane layer 156 may also be any other suitable material. In some embodiments, the resilient membrane layer 156 defines the input valve 132, the diaphragm pump 134, and the outlet valve 142. Further, using resilient membrane layer 156, the diaphragm pump 134 may be sized for metering out a precise amount of the treatment substance fluid 180 to be injected into an egg (not shown). More particularly, the diaphragm pump 134 may include a diaphragm 136 (formed in the resilient membrane layer 156) whose size and amount of deflection may be specifically designed for metering out a precise amount of the treatment substance fluid 180 (e.g. about 50 μl).

The resilient membrane layer 156 is illustrated as a one-piece unit in which each of the input valve 132, the diaphragm pump 134, and the outlet valve 142 are interconnected, while, in other embodiments, one or more respective portions may be disjointed. Further, the inlet/outlet 135 of the diaphragm pump 134 is defined in the first panel 150. Additionally, the outlet port 144 of the outlet valve 142 is defined in the first panel 150. The inlet/outlet 135 of the diaphragm valve 134 and/or the outlet port 144 of the outlet valve 142 may, alternatively, be independent of the first panel 150.

In some embodiments, the resilient membrane layer 156 serves as the elastic membrane for opening and closing the membrane valves/pumps; in particular, for opening and closing the input valve 132, the diaphragm pump 134, and the outlet valve 142. Namely, the resilient membrane layer 156 may be in communication with the fluid channel 122 defined in the first panel 150 for directing flow of fluid therethrough. The resilient membrane layer 156 may also be configured for allowing selective flow-through of fluid through the fluid channel 122 per the input valve 132, the diaphragm pump 134, and the outlet valve 142.

The resilient membrane layer 156 may be configured to provide discrete pressure/vacuum chambers for controlling the flow-through of fluid through the input valve 132, the diaphragm pump 134, and the outlet valve 142. For example, a pressure/vacuum chamber 162 is provided to control the input valve 132, a pressure/vacuum chamber 164 is provided to control the diaphragm pump 134, and a pressure/vacuum chamber 166 is provided to control the outlet valve 142.

The second panel 152 may be configured for supplying a pressure/vacuum source to each of the input valve 132, the diaphragm pump 134, and the outlet valve 142. For example, a pressure/vacuum source 172 may supply the pressure/vacuum chamber 162 of the input valve 132. A pressure/vacuum source 174 may supply the pressure/vacuum chamber 164 of the diaphragm pump 134. A pressure/vacuum source 176 may supply the pressure/vacuum chamber 166 of the outlet valve 142. The pressure/vacuum sources 172, 174, 176 may be individually controlled and may be any of a desired pressure/vacuum source, including a high, low, or vacuum pressure. For example, the pressure/vacuum sources 172, 174, 176 may be capable of providing from about 30 psi to about 300 psi. With respect to vacuum pressure, the pressure/vacuum sources 172, 174, 176 may be capable of providing a vacuum from about 300 millibars to about 950 millibars in one example, or from about 600 millibars to about 700 millibars in another example. In certain other embodiments, however, the pressure/vacuum sources may be capable of supplying greater or lower pressures.

In some embodiments, the pressure/vacuum sources 172, 174, 176 are the mechanisms for actuating the input valve 132, the diaphragm pump 134, and the outlet valve 142. “Actuating” or “actuation” means deflecting the resilient membrane layer 156 to open and/or close the input valve 132, the diaphragm pump 134, and/or the outlet valve 142.

In operation, using the select valve 130 as an example, when pressure source 170 provides a positive pressure, the resilient membrane layer 156 of the select valve 130 may be pushed by pressure against the surface of the first panel 150, thereby blocking the flow of liquid through the inlet and outlet thereof. In so doing, the select valve 130 is closed. By contrast, when pressure source 170 provides a vacuum pressure, the resilient membrane layer 156 of the select valve 130 may be deflected away from the surface of the first panel 150 (i.e., toward the second panel 152). Accordingly, a void or space may be created between the resilient membrane layer 156 and the surface of the first panel 150 through which liquid may flow. In some embodiments, the liquid may be treatment substance fluid 180. In so doing, the select valve 130 is opened. The input valve 132, the diaphragm valve 134, and the outlet valve 142 operate in like manner.

Referring now again to FIG. 4 through FIG. 8, the process of agitating a treatment substance fluid 180 from the pump assembly 110 is summarized as follows. Referring now to FIG. 4, using the respective pressure/vacuum sources 172, 174, 176, the input valve 132 is closed, the diaphragm pump 134 is closed, and the outlet valve 142 is closed. In so doing, no treatment substance fluid 180 is allowed to flow from the fluid reservoir 114 into the pump assembly 110.

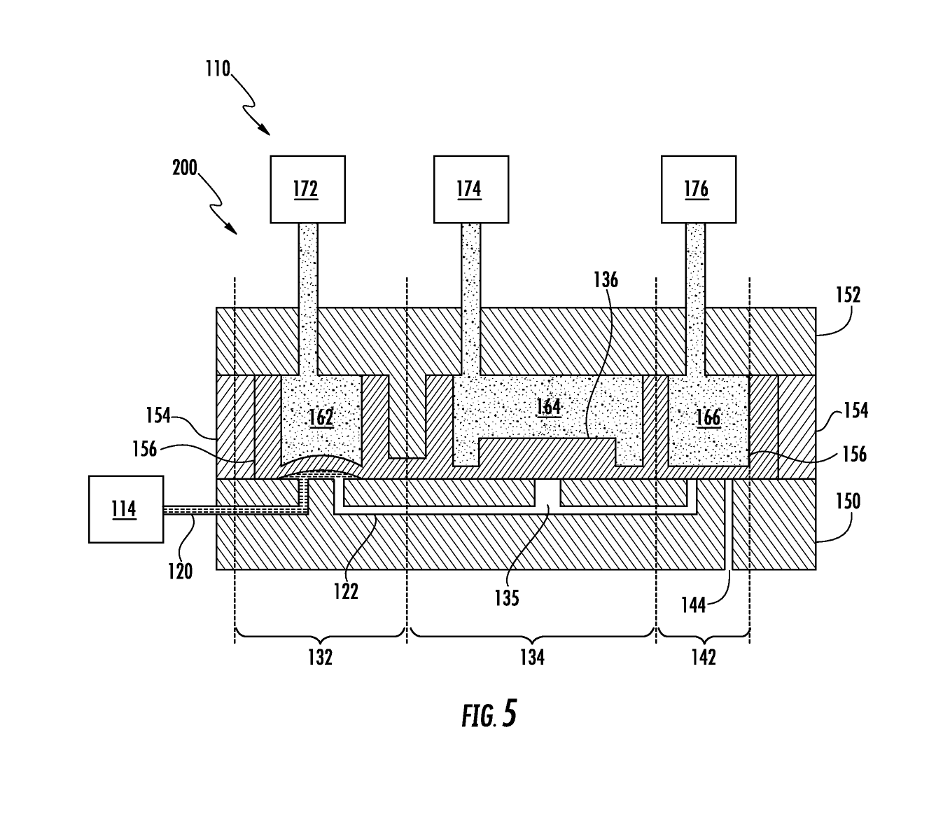

Referring now to FIG. 5, using the respective pressure sources 172, 174, 176, the input valve 132 is opened, the diaphragm pump 134 is closed, and the outlet valve 142 is closed. In so doing, the input valve 132 is prepared to receive the treatment substance fluid 180.

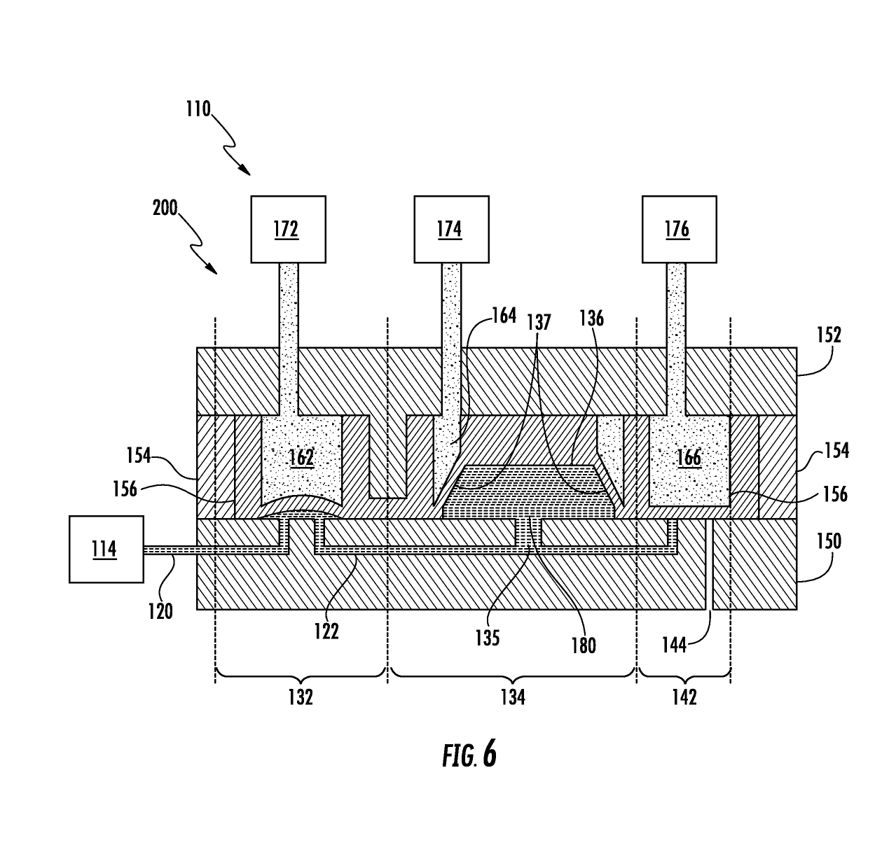

Referring now to FIG. 6, using the respective pressure sources 172, 174, 176, the input valve 132 is opened, the diaphragm pump 134 is opened, and the outlet valve 142 is closed. In so doing, the treatment substance fluid 180 may forwardly flow from the fluid reservoir 114 and into the input valve 132 and the diaphragm pump 134, but not into the outlet valve 142. Namely, in this step a precise amount of the treatment substance fluid 180 may be drawn into the diaphragm pump 134.

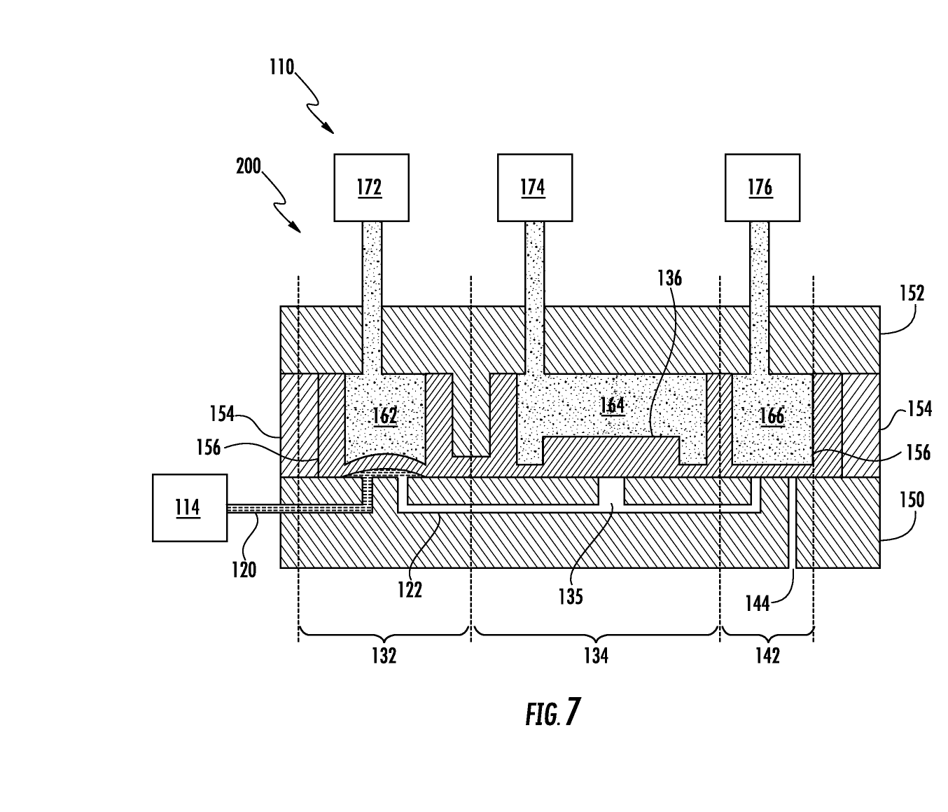

Referring now to FIG. 7, using the respective pressure sources 172, 174, 176, the input valve 132 remains open while the diaphragm pump 134 is closed, and the outlet valve 142 remains closed. In so doing, a the treatment substance fluid 180 staged in the diaphragm pump 134 is pushed out of the diaphragm valve 134, back through the inlet valve 132 and toward the fluid reservoir 114 so as to create a backflow or reverse flow of the treatment substance within the fluid delivery system 100. This process now may be repeated as needed or desired to agitate the fluid within the fluid delivery system 100, wherein the treatment substance fluid is repeatedly drawn into the diaphragm pump and then pumped/forced back toward the fluid reservoir 114. That is, the diaphragm pump 134 may be opened and closed in repetition to agitate the fluid within the fluid delivery system 100 by cycling the diaphragm pump 134. In this regard, the process agitates the fluid treatment substance by alternatingly moving the fluid treatment substance in forward and backward directions within the fluid channels and across the membranes. Such a process may be useful in flushing the fluid delivery system 100 so as to unclog the fluid paths or otherwise creating and/or maintaining homogeneity of the treatment substance by maintaining suspension of particles in the treatment substance to improve efficacy thereof.

The pump assemblies 110 may be individually controlled such that the agitation process described herein may be targeted at discrete pump positions or locations. That is, if a specific area of the fluid delivery system 100 is determined to be clogged, the agitation process can be targeted at such specific area by operating a specific pump assembly or assemblies to swish the specific area. In other instances, all the pump assemblies may be operated concurrently to run the agitation protocol such that the entire fluid delivery system 100 is agitated.

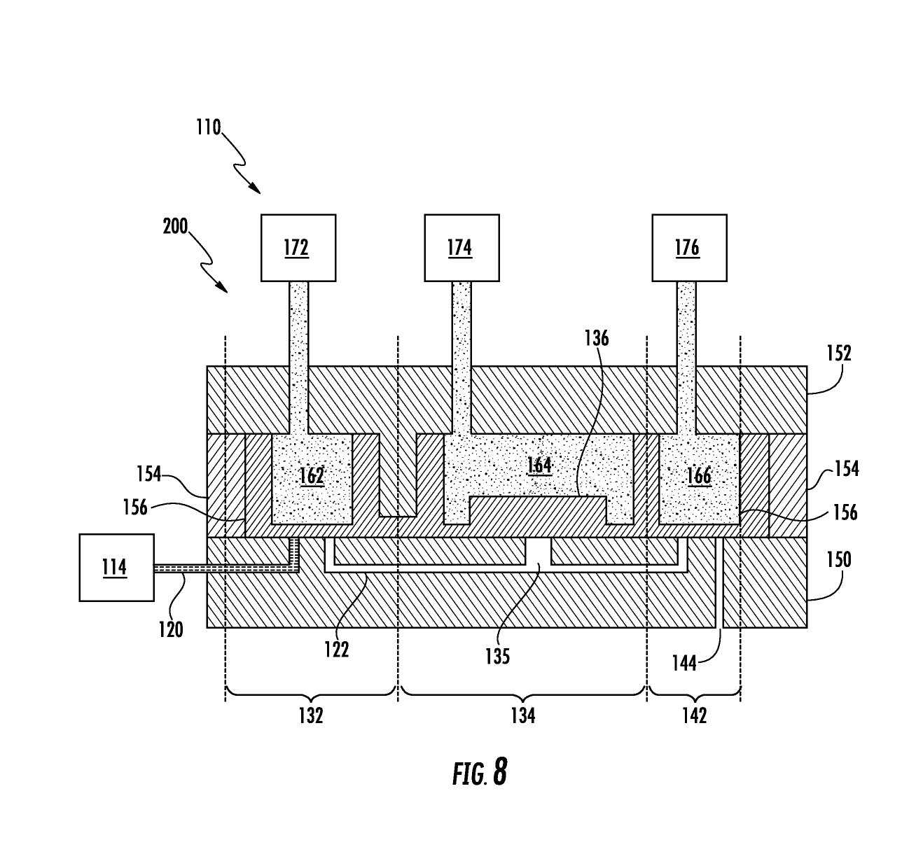

Referring now to FIG. 8, using the respective pressure sources 172, 174, 176, once the treatment substance has been agitated sufficiently or as-desired and/or the fluid paths have been flushed and cleared of any debris, the diaphragm pump 134 is closed, followed by closing of the input valve 132, resulting in a return to pump starting position (ready to begin a dispense sequence).

A controller 500 may be provided for controlling operation and sequencing of the pump assemblies 110. In some instances, the controller 500 may be programmed to run an agitation protocol/program or flushing protocol/program on-demand with actuation of an actuator (e.g., a push button) by an operator. In other instances, the controller 500 may be programmed to run an agitation protocol, sequence or program between each injection cycle such that the treatment substance fluid is agitated between each injection cycle or sequence. In this regard, the controller 500 may sequence the input valve 132 and the diaphragm pump 134 as described previously with respect to FIG. 4 through FIG. 8. In some instances, the agitation protocol may include an agitation or flushing sequence at varying frequencies, which may be based on the make-up of the vaccine or fluid substance being transported.

While the above description is directed to pumping of a treatment substance fluid, it is also conceived that the flushing/agitation of a fluid within the fluid delivery system 100 may be implemented for cleaning the fluid delivery system 100 with a cleaning or sanitizing fluid. In such instance, the fluid delivery system 100 may be fluidly connected to a cleaning module rather than a fluid reservoir containing a treatment substance. In this manner, a cleaning or sanitizing fluid may be circulated within the fluid delivery system 100 to flush the system, in accordance with the process described with respect to FIG. 4 through FIG. 8, after transporting a treatment substance fluid therethrough.

Many modifications and other aspects of the present disclosure set forth herein will come to mind to one skilled in the art to which this disclosure pertains having the benefit of the teachings presented in the foregoing descriptions and the associated drawings. Therefore, it is to be understood that the present disclosure is not to be limited to the specific aspects disclosed and that modifications and other aspects are intended to be included within the scope of the appended claims. Although specific terms are employed herein, they are used in a generic and descriptive sense only and not for purposes of limitation.

That which is claimed:

1. A fluid delivery system for an in ovo injection apparatus, the fluid delivery system comprising a fluid agitation system having a plurality of pump assemblies each in fluid communication with an injection delivery device, the pump assemblies comprising a membrane pump and a plurality of membrane valves interconnected by fluid channels, wherein the membrane pump and membrane valves comprise a diaphragm configured in open and closed positions for agitating a fluid treatment substance by reversing flow of the fluid treatment substance within the fluid channels.

2. The fluid delivery system of claim 1, wherein the membrane valves comprise an input valve and an outlet valve, the input valve being in fluid communication with a fluid reservoir and the outlet valve being in communication with a respective injection delivery device.

3. The fluid delivery system of claim 1, further comprising a controller configured to sequence the membrane pump and membrane valves in order to agitate the fluid treatment substance between operations of the injection delivery devices.

4. The fluid delivery system of claim 1, wherein the membrane pump and membrane valves comprise a pressure/vacuum chamber and a resilient membrane.

5. The fluid delivery system of claim 1, further comprising a pressure/vacuum source in individual communication with the membrane pump and membrane valves so as to facilitate selective and individual control of each.

6. A method of agitating a fluid treatment substance within a fluid delivery system of an in ovo injection apparatus, the method comprising providing a plurality of pump assemblies in fluid communication with respective injection delivery devices via fluid channels, and operating the pump assemblies so as to agitate a fluid treatment substance by alternatingly moving the fluid treatment substance in forward and backward directions within the fluid channels.

7. A method according to claim 6, wherein providing a plurality of pump assemblies comprises providing a plurality of pump assemblies having a membrane pump and a plurality of membrane valves interconnected by fluid channels, wherein the membrane pump and membrane valves comprise a diaphragm configured in open and closed positions for agitating a fluid treatment substance by reversing flow of the fluid treatment substance within the fluid channels.

8. A method according to claim 7, wherein membrane valve comprises a diaphragm pump and the membrane valves comprise an input valve and an outlet valve, the input valve being in fluid communication with a fluid reservoir and the outlet valve being in communication with a respective injection delivery device, and the diaphragm pump being disposed between the input valve and the outlet valve.

9. A method according to claim 8, wherein operating the pump assemblies comprises:
(a) opening the input valve;
(b) opening the diaphragm pump to draw the fluid treatment substance through the input valve and into the diaphragm pump; and
(c) closing the diaphragm pump to force the fluid treatment substance back through the input valve so as to create a reverse flow of the fluid treatment substance.

10. A method according to claim 9, wherein steps (b) and (c) are repeated according to a fluid agitation protocol.
